(19) United States
(12) Patent Application Publication
(10) Pub. No.: US 2010/0259803 A1
(43) Pub. Date: Oct. 14, 2010

(54) COLLINEAR VOLUME HOLOGRAPHIC OPTICAL STORAGE SYSTEM AND INFORMATION STORAGE STRUCTURE THEREOF

(76) Inventors: Ching-Cherng SUN, Hsinchu (TW); Yeh-Wei Yu, Hsinchu (TW); Shu-Ching Hsieh, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/475,854

(22) Filed: Jun. 1, 2009

(30) Foreign Application Priority Data
Apr. 14, 2009 (TW) 98112270

(51) Int. Cl. G03H 1/26; G03H 1/02

(52) U.S. Cl. 359/22; 359/3

(57) ABSTRACT

A collinear volume holographic optical storage system records a plurality pages of holographic data on the storage material, where the intensity distribution of the saved recorded holographic data of each page is in a “+” format. It is possible to incur the inter-page cross talk between two adjacent pages of holographic data along the storage track or between two adjacent storage tracks. An rotation angle between the direction of the distribution of the volume grating and the direction of the storage track can be used to increase the descendent of data storage intensity along storage track, so the effect of the inter-page cross talk is decreased; or the distance between reading centers of two pages of holographic data is shorten to increase the storage density of the storage material.

### FIELD OF THE INVENTION

The present invention relates to a collinear volume holographic optical storage system and data storage structure; and more particularly a specific angle is included between the direction of the data storage intensity and the track direction of the storage material to decrease the inter-page cross talk and to increase the capability of the storage material.

### BACKGROUND OF THE INVENTION

As shown in FIG. 1, an image 10 formed by a spatial light modulator of a collinear volume holographic optical storage system includes a signal light in the center part and a reference light in the surrounding part. The interference fringe of the signal light and the reference light constructs an information page of holographic optical image.

In the writing process, the information page of holographic optical image including signal and reference is focused on a storage material 30 using a objective lens 20, and the refractive index of the storage material 30 is altered to form a volume grating on the storage material. In the reading process, a reading light, the same as the reference light in general, impinges into the volume grating of the storage material 30 to diffract the reconstructed signal. Therefore, the volume grating can be used to record the information.

The information recorded in volume grating is a kind of light information under Fourier transformation, and the signal light modulated by a signal light modulator, which is in the center part of spatial light modulator. The signal light modulator includes a plurality of pixels and the pixel has a rectangle shape, so the intensity of the light information forms a “+” shape distribution after Fourier transformation and recorded on the storage material 30, as shown in the storage area A of FIG. 1. One intensity direction is along the direction (tangential direction) of the storage tracks 309, 310 and 311 of the storage material 30, and the other intensity direction is along the radial direction of the storage material 30 (perpendicular with the tangential direction of the storage track). The intensity direction along the storage track direction is defined as x-axis and the other intensity direction as y-axis, and the cross center of the “+”-shaped intensity is the reading center, which is the incident center of the reading light.

FIG. 2 shows two adjacent reading centers of the intensity distribution along a storage track direction (x-direction) of the holographic light information. The intensity of a holographic light information page does not decrease to zero at the reading center of the next (adjacent) holographic light information page as shown as area C in FIG. 2, which causes what called inter-page cross talk. For the same reason, the inter-page cross talk also appear when two neighboring holographic light information pages are stored on two adjacent storage tracks.

Therefore, the distance between two holographic light information pages has to be far enough to eliminate the inter-page cross talk. However, it reduces the storage density of the storage material 30.

### SUMMARY OF THE INVENTION

An aspect of the present invention uses an included angle between the direction of the holographic light information and the direction of the storage track direction to decrease the intensity in adjacent page. The intensity decreases quickly along the track direction of the storage material to reduce the effect of the inter-page cross talk of two adjacent holographic information pages. Further, the fast reduction of the intensity decreases the distance of two adjacent holographic information pages to increase the storage density.

An aspect of the present invention rotates the spatial light modulator to rotate the holographic image with an angle to the storage track direction of the storage material. The rotated holographic image can reduce the effect of the inter-page cross talk and increase the storage density of the storage material.

### BRIEF DESCRIPTION OF THE DRAWINGS

FIG. 1 shows a schematic diagram of a collinear volume holographic storage system, and the storage area A is used to illustrate geometric relationship of the holographic information pages on a storage material.

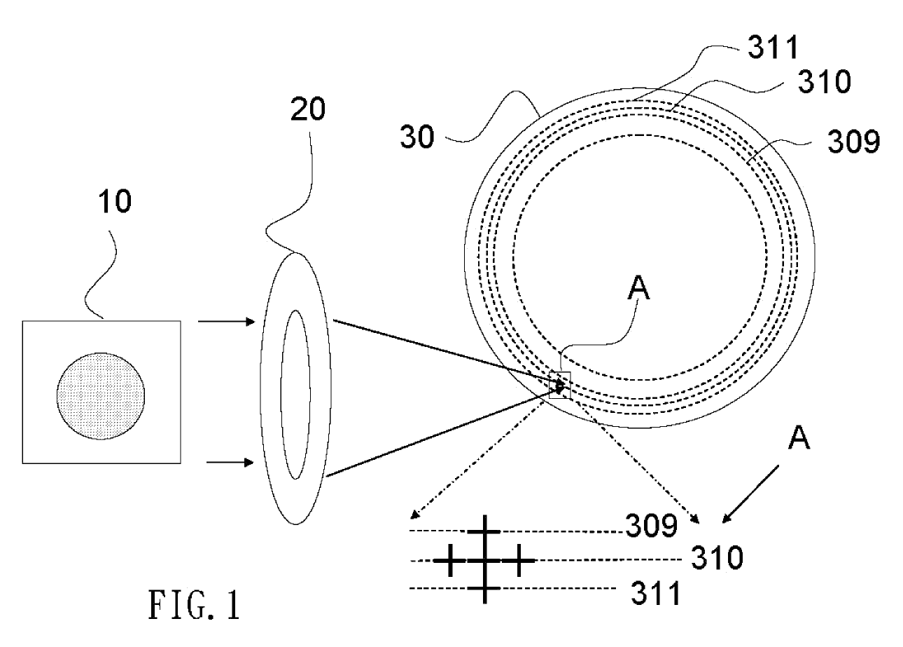

FIG. 2 shows the intensity distribution of two adjacent holographic information pages of the embodiment shown in FIG. 1.

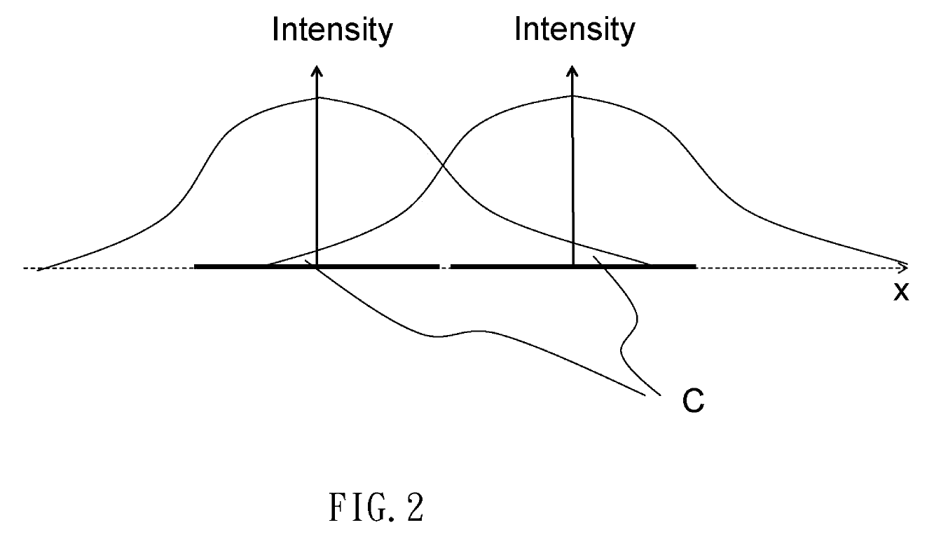

FIG. 3 shows a schematic diagram of a collinear volume holographic storage system, and the storage area B is used to illustrate the geometric relationship of the holographic information pages on the storage material, wherein the holographic information pages are rotated.

FIG. 4 shows the intensity distribution of two adjacent holographic information pages of the embodiment shown in FIG. 3.

### DESCRIPTION OF THE EXEMPLARY EMBODIMENTS

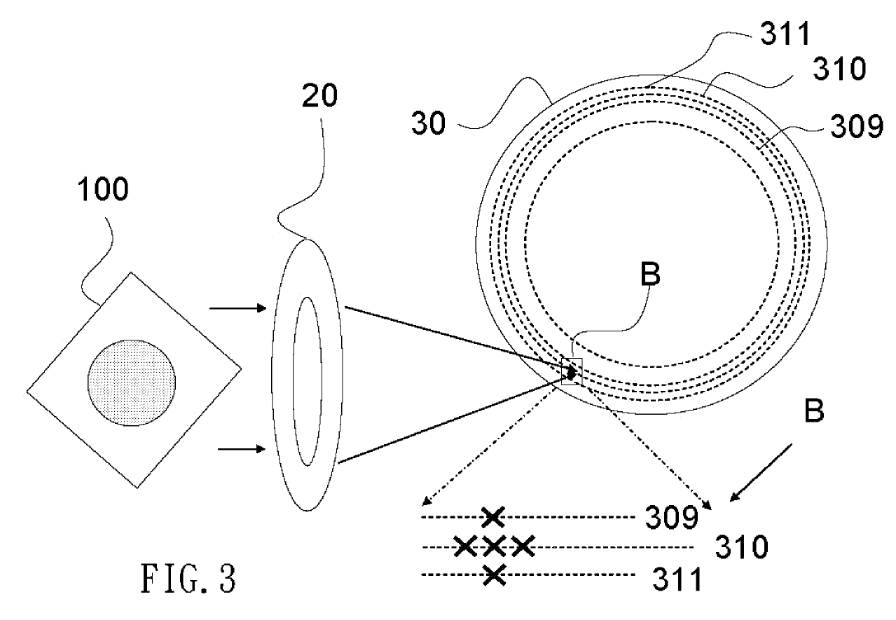

FIG. 3 shows the schematic diagram of a collinearvolume holographic optical storage system. A real image 100 of the spatial light modulator of the collinear volume holographic optical storage system includes a signal light in the center part and a reference light in the surrounding part of the real image 100. The interference fringe constructed by the signal light and the reference light contains an information page of holographic optical data, which is focused on a storage material 30 by a objective lens 20 and recorded on the storage material 30. The storage material 30 includes a plurality of parallel storage tracks, such as the three adjacent dot lines 309, 310 and 311 in the figure. The information pages of the holographic data are expressed as “+”, which means the direction of the intensity distribution, and recorded along the storage tracks of the storage material 30 in one page one time, as shown in the storage area B in the figure. As shown in the figure, the direction of the intensity distribution is not parallel to the storage direction (tangential direction) and the radial direction but with an included angle.

The real image 100 formed by the spatial light modulator is focused on the storage material 30 by a objective lens 20, and then the focused light alters the property of the storage material to form a volume gate, which is used to record the data constructed by the signal light. A reading light, the conjugate light of the reference light in general, impinges into the volume grating of the storage material 30 to form a diffractive image (diffractive optical field), which can reconstruct the signal light.

The distribution of the volume grating is the Fourier Transform of the image 100 in general. The center part of the image 100 is the signal light and the surrounding part is the reference light. The signal light is modulated by the center part of the spatial light modulator, called a signal light modulator, and the signal light modulator includes a plurality of pixels with rectangle shape. One page of the signal light of the image 100 is transformed by the objective lens 20 to form a “+”-shaped intensity distribution, and the center of the “+” is the reading center. Therefore those information pages of the holographic optical data are recorded on the storage material along the storage tracks with “+” shape, and the inter-page cross talk is induced as the distance between two reading centers of the holographic data is too near.

The distance between two adjacent pages of the holographic data of the same storage track 310 or two nearest storage tracks 309, 311 affects the storage density of the storage material 30. The shorter the distance increase higher density. Therefore, it can increase the density and decrease the effect of the inter-page cross talk by changing the structure (arrangement) of the holographic data.

For example, by accelerating the reduction of the storage intensity away from the reading center, the inter-page cross talk effect may be decreased and the storage density may be increased. An embodiment proposes configuring an included angle between the direction of the widest range of the storage intensity and the direction (tangential direction) of the storage track to decrease of the storage intensity quickly to reach or almost reach 0 at the next reading center. Thus, the inter-page cross talk effect is decreased.

The effect to reduce the inter-page cross talk using the above technique of rotating the direction of the holographic data will cease as adding an aperture with size nearly Nyquist aperture on the Fourier plane (also called frequency domain, which is the back focal plane of the objective lens or the conjugate image of the optical field in the back focal plane of the objective lens). The Nyquist aperture means the smallest aperture through which a light with the minimum frequency spectrum with the ability of transferring data may be passed.

In general, the Fourier transformation of an optical field (light), also called frequency spectrum, can be obtained using a lens. Two planes separated from the lens with focal distance, on the side of the source light called front focal plane, and the other side of the Fourier image called back focal plane, also called Fourier plane or frequency domain. In the embodiment, the image 100 of the spatial light modulator is formed on the front focal plane and the corresponding Fourier image on the Fourier plane. An aperture is configured on the Fourier plane. The page of the holographic data can not be formed in “+” shape to limit the effect of the above technique when the aperture size is nearly Nyquist aperture. If the aperture size is large enough to let the whole image 100 of the spatial light modulator pass through, then the size of the reference light (the real image of surrounding part of the spatial light modulator) is limited by the spatial light modulator with a rectangle shape to have a “+” shaped intensity again after Fourier transformation. Once the “+”-shaped intensity is formed, the present invention can be used to decrease the inter-page cross talk whether the Nyquist aperture exists or not.

The following example is used to illustrate the spirit of the present invention. For convenience, the x-axis and the y-axis are respectively defined as the tangential direction and radial direction of the storage track. As shown as FIG. 3, the direction of the storage intensity is rotated to have an included angle between x- and y-axis, so the projection of the storage intensity is shorter to have a quick reduction of the intensity along x- and y-axis. The included angle is larger 0 degree and smaller then 90 degree.

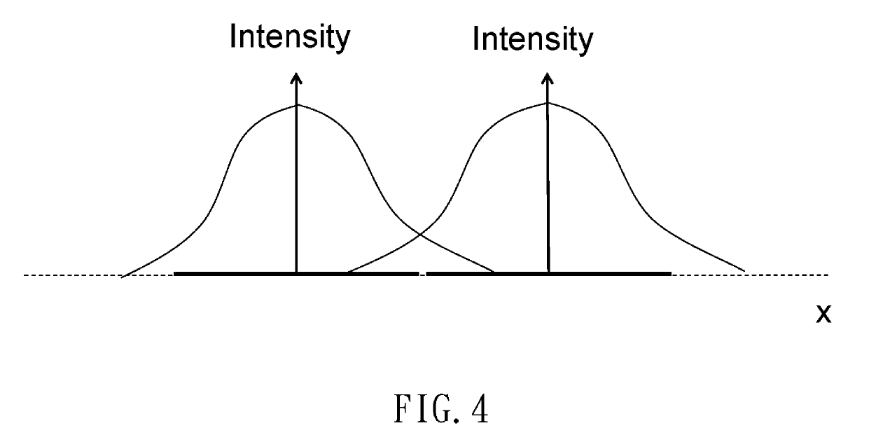

As shown as FIG. 4, the storage intensities of two adjacent holographic data along a storage track with a rotated angle to the x-axis is drawn for explaining the storage intensity distribution. The direction of the storage intensity is rotated as holographic data is rotated, so the maximum storage intensity is rotated to the middle orientation between x-axis and y-axis and has less weight of the storage intensity along x-axis and y-axis. As shown as FIG. 4, the storage intensity quickly decays along x-axis to reduce the inter-page cross talk.

For an example of 45 degree rotation angle, the reduction velocity of the intensity is \sqrt{2} times than before with 0 degree rotation angle, so the distance of two adjacent reading centers reduces 1/\sqrt{2} time. In the same reason, the distance of two adjacent storage tracks also reduces 1/\sqrt{2} time. Therefore, the storage density will increase 2 times than before.

The distribution of the volume grating for one page of data in the storage material is just the Fourier transform of the real image of the spatial light modulator. So we can just rotate the spatial light modulator to rotate the distribution of the volume grating.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A storage structure of a collinear volume holographic optical storage system, wherein a storage material of said collinear volume holographic optical storage system comprises a plurality of storage tracks, and at lease one holographic data page one time is recorded on said storage material along said storage tracks, wherein a direction of the distribution of the volume grating of said holographic data page and the tangential direction of said tracks has an included angle, and said included angle is larger than 0 degree and smaller than 90 degree.

2. A storage structure of a collinear volume holographic optical storage system of claim 1, wherein said included angle is 45 degree.

3. A collinear volume holographic optical storage system, comprising:
a spatial light modulator to form at least one page of a holographic data;
a storage material, configured in the rear of said spatial light modulator, comprising a plurality of storage tracks; and
a lens configured between said spatial light modulator and said storage material to focus said holographic data pages on said storage tracks to record said holographic data on said storage material, wherein the center part of said holographic data page is a signal light and the surrounding part is a reference light, and the interfere fringe of said signal light and said reference light constructed said volume grating of holographic data page, wherein the direction of distribution of the volume grating of said holographic data on said storages tracks and the tangential direction of said storage tracks comprises an included angle, and said included angle is larger than 0 degree and smaller than 90 degree.

4. A collinear volume holographic optical storage system of claim 3, wherein said spatial light modulator is rotated with said included angle to form said included angle of said storage intensity distribution.

5. A collinear volume holographic optical storage system of claim 3, wherein said included angle is 45 degree.
